(19) United States
(12) Patent Application Publication
(10) Pub. No.: US 2009/0228538 A1
(43) Pub. Date: Sep. 10, 2009

(54) MULTI INPUT CODING ADDER, DIGITAL FILTER, SIGNAL PROCESSING DEVICE, SYNTHESIZER DEVICE, SYNTHESIZING PROGRAM, AND SYNTHESIZING PROGRAM RECORDING MEDIUM

(76) Inventors: Kouichi Nagano, Osaka (JP); Hiroyuki Nakahira, Kyoto (JP)

Correspondence Address: WENDEROTH, LIND & PONACK L.L.P., 1030 15th Street, N.W., Suite 400 East, Washington, DC, 20005-1503, US

(21) Appl. No.: 12/092,938

(22) PCT Filed: Oct. 24, 2006
(86) PCT No.: PCT/JP2006/321182

§ 371 Date: May 7, 2008

(51) Int. Cl. G06F 7/52; G06F 7/00

(52) U.S. Cl. 708/209; 708/620

(57) ABSTRACT

Conventional multi-input multiplication and addition circuit having fixed multipliers has problems in that when the number of inputs increases, the number of partial product generator circuits would increase, and also the number of stages of the addition blocks would increase.

In order to solve the above-described problems, it is constructed such that there are provided a multi-input encoder (11) which comprises a plurality of encoder parts (11a) each of which accomplishes a function corresponding to generation of a partial product in multiplication, and which also has a plurality of outputs which correspond to the multi-bit output of the respective encoder parts, and a multi-input adder circuit (12) which adds the plural outputs from the multi-input encoder (11).

### TECHNICAL FIELD

The present invention relates to a multi-input coding adder, and more particularly, to a multi-input coding adder which can carry out an operation that is equivalent to an operation of a multi-input multiplier and adder which multiply a plurality of inputs by constant multipliers, respectively, and adds the plural multiplication results together by a smaller circuit.

### BACKGROUND ART

A circuit which multiplies inputs by constants, and calculates the sum of the plural outputs is used in various signal processing and in digital filters, and it has a lot of applications.

The above-described circuit is constituted by constant multipliers, a multi-input adder, and the like, and miniaturization and speeding up are demanded.

Up until now, a lot of patent applications are filed on the constructions of constant multipliers and multi-input adders (for example, refer to Patent Document 1, Patent Document 2, and Patent Document 3).

FIG. 9 is a diagram illustrating a construction of a multi-input multiplier and adder according to a prior art example. In FIG. 9, reference numeral 20a, 20b, 20c, . . . , 20n denote partial product generators, respectively. Numeral 92 denotes a multi-input adder circuit, and numerals 93a, 93b, 93c, . . . , 93n denote two-input adder blocks which constitute the multi-input adder circuit 92. The multi-input multiplier and adder shown in FIG. 9 is a circuit which multiplies the input signals by constant multipliers respectively, and adds the plural multiplication outputs obtained by the multiplications together.

For multiplying the input signal by a constant multiplier, a logical product operation is usually used to obtain respective partial products. The partial product generator circuits 20a, 20b, 20c, 20n generate partial products of the respective inputs and the constant multipliers for each bit. The two-input adder blocks 93a, 93b, 93c, 93n are constituted by providing a plurality of two-input one-output adders, respectively, and by employing these in a plurality of stages, the sum of the outputs of the partial product generators 20a, 20b, 20c, 20n is obtained. The number of the adders of the two-input one-output adders in the final stage two-input adder block 2n is 1.

In addition, FIG. 10 shows an example of a multi-input multiplier and adder which has an input number of 4. The circuit shown in FIG. 10 is a usual FIR filter. In FIG. 10, numerals 21a, 21b, 21c, and 21d denote multiplier circuits, respectively, and numeral 5a, 5b, and 5c denote adder circuits, respectively.

The multiplier circuits 21a, 21b, 21c, and 21d multiply four inputs by a coefficient 1, a coefficient 2, a coefficient 3, and a coefficient 4, respectively, and outputs the results, respectively. The adder circuits 5a, 5b, and 5c are two-input one-output adders, respectively, and these obtain the sum of the outputs of the multiplier circuits 21a, 21b, 21c, and 21d.

Patent Documents 1: Japanese Patent No. 3558436

Patent Documents 2: Japanese Published Patent Application No.Hei.5-233226

Patent documents 3: Japanese Published Patent Application No.Hei.10-124298

### DISCLOSURE OF THE INVENTION

### Problems to be Solved by the Invention

The conventional multi-input coding adder circuit having constant multipliers has a problem in that when there is an increase in the number of inputs, there occurs an increase in the number of the partial product generator circuits and also an increase in the number of stages of the addition blocks. Herein, a partial product generator circuit requires, when, for example, the input has j bits and the coefficient has k bits, j×k pieces of AND circuits, and with an increase in the inputs, the circuit scale increases to a great extent.

The present invention is directed to solving the problems in the above-described conventional technique, and has for its object to provide a multi-input coding adder circuit which can reduce its circuit scale in its circuit construction, and further to provide a synthesizer device, a synthesizing program, and a synthesizing program recording medium for that multi-input coding adder circuit.

### Measures to Solve the Problems

In order to solve the above-described problems, according to claim 1 of the present invention, there is provided a multi-input coding adder, being an operator which multiplies a plurality of inputs by fixed multipliers, respectively, and adds all the multiplication results together to output the added result, comprising: a multi-input encoder which, comprising a plurality of encoder parts each of which accomplishes a function corresponding to generation of a partial product in a multiplication, each of the plural inputs to which encoder is an input of each said encoder part, and which encoder has plural outputs each of which is the multi-input output of each said encoder part, and a multi-input adder circuit which adds the plural outputs of said multi-input encoder, which are the multi-bit output of each said encoder part.

Thereby, by employing a small sized multi-input encoder and a multi-input adder circuit without employing a partial product generator circuit, it is possible to realize reduction in a circuit scale, and to realize an operator which can perform an operation that is equivalent to the operation by a conventional multi-input multiplier and adder with a miniaturized circuit construction.

According to claim 2 of the present invention, there is provided a multi-input coding adder circuit as defined in claim 1, wherein: said multi-input adder circuit comprises a multi-input adder which receives the plural outputs of said multi-input encoder as its inputs, which are the multi-bit output of each of said encoder parts of said multi-input encoder, and adds these inputs together.

Thereby, by employing a small sized multi-input encoder and a multi-input adder circuit without employing a partial product generator circuit, it is possible to realize reduction in a circuit scale, and to obtain a small sized multi-input coding adder.

According to claim 3 of the present invention, there is provided a multi-input coding adder as defined in claim 1, wherein: each said encoder part constituting said multi-input encoder includes a plurality of encoder units which generate respectively partial products which respectively correspond to the plural coefficient patterns which are obtained by partitioning the bit pattern of the fixed multiplier into each plural bits, and at least one of said plural encoder units comprises: an inverter for inverting each bit of said input signal; an adder circuit which adds a constant to the output of said inverter; a selection circuit for selecting either of said input signal and the output signal of said adder circuit according to said coefficient pattern to output the selected result; and a bit-shift circuit which carries out a bit-shift of the output signal of said selection circuit.

Thereby, it is possible to realize reduction in a circuit scale for the respective encoder parts which constitute the multi-input encoder, and thereby to obtain a small-sized multi-input coding adder.

According to claim 4 of the present invention, there is provided a multi-input coding adder as defined in claim 1, wherein: each said encoder part constituting said multi-input encoder includes a plurality of encoder units which generate respectively partial products which respectively correspond to plural coefficient patterns which are obtained by partitioning the bit pattern of the fixed multiplier into each plural bits, and at least one of said plural encoder units comprises: an inverter for inverting each bit of said input signal; an adder circuit which adds a constant to the output of said inverter; a bit-shift circuit which carries out a bit-shift of the output signal of said adder circuit.

Thereby, it is possible to realize reduction in a circuit scale for the respective encoder parts which constitute the multi-input encoder, and thereby to obtain a small-sized multi-input coding adder.

According to claim 5 of the present invention, there is provided a multi-input coding adder circuit as defined in claim 1, wherein: each said encoder part constituting said multi-input encoder includes a plurality of encoder units which generate respectively partial products which respectively correspond to plural coefficient patterns which are obtained by partitioning the bit pattern of the fixed multiplier into each plural bits, and at least one of said plural encoder units comprises a bit-shift circuit which carries out a bit-shift of said input signal.

Thereby, it is possible to realize reduction in a circuit scale for the respective encoder parts which constitute the multi-input encoder, and thereby to obtain a small-sized multi-input coding adder.

According to claim 6 of the present invention, there is provided a multi-input coding adder circuit as defined in claim 1, wherein: each said encoder part constituting said multi-input encoder employs a Booth-algorithm.

Thereby, the reduction in a circuit scale for the respective encoder parts can be realized, and thereby, a small-sized multi-input coding adder can be obtained.

According to claim 7 of the present invention, there is provided a multi-input coding adder circuit as defined in claim 2, wherein: said multi-input adder is a Wallace Tree adder.

Thereby, the reduction in a circuit scale for the multi-input adder can be realized, and thereby, a small-sized multi-input coding adder can be obtained.

According to claim 8 of the present invention, there is provided an operator as a multi-input coding adder, being an operator which multiplies a plurality of inputs by fixed multipliers, respectively, and adds all the multiplication results together, comprising: a multi-input encoder which, comprising a plurality of encoder parts each of which accomplishes a function corresponding to generation of a partial product in a multiplication, each of the plural inputs to which encoder is an input of each said encoder part, and which encoder has plural outputs each of which is the multi-input output of each said encoder part, and a multi-input adder circuit which adds the plural outputs of said multi-input encoder, which are the multi-bit output of each said encoder part, and a constant.

Thereby, by employing a small sized multi-input encoder and a multi-input adder circuit without employing a partial product generator circuit, it is possible to realize reduction in a circuit scale, and to realize an operator which can perform an operation that is equivalent to the operation by a conventional multi-input multiplier and adder with a miniaturized circuit construction.

According to claim 9 of the present invention, there is provided a multi-input coding adder circuit as defined in claim 8 wherein: each said encoder part constituting said multi-input encoder includes a plurality of encoder units which generate respectively partial products which respectively correspond to the plural coefficient patterns which are obtained by partitioning the bit pattern of the fixed multiplier into each plural bits, and at least one of said plural encoder units comprises: an inverter for inverting each bit of said input signal; an adder circuit which adds a constant to the output of said inverter; a selection circuit for selecting either of said input signal and the output signal of said adder circuit according to said coefficient pattern to output the selected result; and a bit-shift circuit which carries out a bit-shift of the output signal of said selection circuit.

Thereby, the reduction in a circuit scale for the respective encoder parts which constitute the multi-input encoder can be realized, and thereby a small sized multi-input coding adder can be obtained.

According to claim 10 of the present invention, there is provided a multi-input coding adder, being an operator which multiplies a plurality of inputs by fixed multipliers, respectively, and adds all the multiplication results together to output the added result, comprising: a multi-input encoder which, comprising a plurality of encoder parts each of which accomplishes a function corresponding to generation of a partial product in a multiplication, each of the plural inputs to which encoder is an input of each said encoder part, and which encoder has plural outputs each of which is the multi-input output of each said encoder part, and a column position adjusting circuit which, with receiving the multi-bit outputs of the respective encoder parts which constitute said multi-input encoder as its inputs, carries out an adjustment of the column positions of said respective inputs.

Thereby, by employing a small sized multi-input encoder and a multi-input adder circuit without employing a partial product generator circuit, it is possible to realize reduction in a circuit scale, and to realize an operator which can perform an operation that is equivalent to the operation by a conventional multi-input multiplier and adder with a miniaturized circuit construction.

According to claim 11 of the present invention, there is provided a multi-input coding adder as defined in claim 10, wherein: each said encoder part constituting said multi-input encoder includes a plurality of encoder units which generate respectively partial products which respectively correspond to plural coefficient patterns which are obtained by partitioning the bit pattern of the fixed multiplier into each plural bits, and at least one of said plural encoder units comprises: an inverter for inverting each bit of said input signal; an adder circuit which adds a constant to the output of said inverter; a selection circuit for selecting either of said input signal and the output signal of said adder circuit according to said coefficient pattern to output the selected result; and a bit-shift circuit which carries out a bit-shift of the output signal of said selection circuit.

Thereby, it is possible to realize reduction in a circuit scale for the respective encoder parts which constitute the multi-input encoder, and thereby to obtain a small-sized multi-input coding adder.

According to claim 12 of the present invention, there is provided a digital filter that is provided with a means for multiplying a plurality of inputs by fixed multipliers, respectively, and adds all the multiplication results together, wherein: said means for multiplying a plurality of inputs by fixed multipliers, respectively, and adds all the multiplication results together is constituted by a multi-input coding adder as defined in claim 1.

Thereby, a digital filter can be realized by employing a small sized multi-input encoder and a multi-input adder circuit without employing a partial product generator circuit, thereby enabling reduction in a circuit scale, and resulting in a digital filter of a miniaturized circuit construction.

According to claim 13 of the present invention, there is provided a signal processing device comprising: said multi-input coding adder circuit according to claim 1, and performing a signal processing including multiplying said plural inputs by fixed multipliers, respectively, and adding all the multiplication results together.

Thereby, a signal processing device can be realized by employing a small sized multi-input encoder and a multi-input adder circuit without employing a partial product generator circuit, thereby enabling reduction in a circuit scale, and resulting in a signal processing circuit of a miniaturized circuit construction.

According to claim 14 of the present invention, there is provided a synthesizer device for synthesizing a multi-input coding adder circuit, which is being an operator which multiplies a plurality of inputs by fixed multipliers, respectively, and adds all the multiplication results together, by execution of a program by a computer, which operator comprising: a multi-input encoder which, comprising a plurality of encoder parts each of which accomplishes a function corresponding to generation of a partial product in a multiplication, each of the plural inputs to which encoder is an input of each said encoder part, and which encoder has plural outputs which are the multi-bit output of each said encoder part, and a multi-input adder circuit which adds the plural outputs of said multi-input encoder, which are the multi-bit output of each said encoder part of said multi-input encoder.

Thereby, it is possible to realize a synthesizer device which can automatically synthesizes a small-sized multi-input coding adder, which employs a small-sized multi-input encoder and a multi-input adder without employing a partial product generator circuit.

According to claim 15 of the present invention, there is provided a synthesizer device for synthesizing a multi-input coding adder circuit, as defined in claim 14, wherein: each said encoder part constituting said multi-input encoder includes a plurality of encoder units which generate respectively partial products which respectively correspond to the plural coefficient patterns which are obtained by partitioning the bit pattern of the fixed multiplier into each plural bits, and at least one of said plural encoder units comprises: an inverter for inverting each bit of said input signal; an adder circuit which adds a constant to the output of said inverter; a selection circuit for selecting either of said input signal and the output signal of said adder circuit according to said coefficient pattern to output the selected result; and a bit-shift circuit which carries out a bit-shift of the output signal of said selection circuit.

Thereby, it is possible to reduce the circuit scale of the respective encoder parts which constitute the multi-input encoder of the above-described multi-input coding adder synthesized, and to realize a synthesizer device which can automatically synthesize a small-sized multi-input coding adder.

According to claim 16 of the present invention, there is provided a synthesizing program for synthesizing a multi-input coding adder, comprising: synthesizing a multi-input coding adder as defined in claim 1 by being executed by a computer.

Thereby, it is possible to obtain a synthesizing program which can automatically synthesizes a small-sized multi-input coding adder which employs a small-sized multi-input encoder and multi-input adder, without employing a partial product generator circuit.

According to claim 17 of the present invention, there is provided a synthesizing program recording medium for a multi-input coding adder, comprising: having stored a synthesizing program for synthesizing a multi-input coding adder as defined in claim 16.

Thereby, it is possible to obtain a synthesizing program recording medium which can automatically synthesizes a small-sized multi-input coding adder which employs a small-sized multi-input encoder and a multi-input adder, without employing a partial product generator circuit.

### EFFECTS OF THE INVENTION

According to a multi-input coding adder circuit of the present invention, since a small sized multi-input encoder and a multi-input adder circuit are employed without employing a partial product generator circuit when constituting a circuit, it is possible to realize an operator which can perform an operation that is equivalent to the operation by a conventional multi-input multiplier and adder with a miniaturized circuit construction.

According to a synthesizer device for a multi-input coding adder, a synthesizing program, and a synthesizing recording medium of the present invention, since a small sized multi-input encoder and a multi-input adder circuit are employed without employing a partial product generator circuit, it is possible to obtain a synthesizer device, a synthesizing program, and a synthesizing program recording medium which can perform synthesis of a miniaturized multi-input coding adder.

### BRIEF DESCRIPTION OF THE DRAWINGS

FIG. 1 is a block diagram illustrating a construction of a multi-input coding adder 10 according to a first embodiment of the present invention.

FIG. 2 is a block diagram illustrating a construction of the encoder part 11a in the multi-input encoder 11 of the first embodiment.

FIG. 3 is a block diagram illustrating a construction of the encoder unit 11b in the encoder part 11a in the multi-input encoder 11 of the first embodiment.

FIG. 4 is a block diagram illustrating other construction examples of the encoder unit 11b-2 and 11b-3 in the encoder part 11a in the multi-input encoder 11 of the first embodiment.

FIG. 5 is a block diagram illustrating a construction of a multi-input coding adder 50 according to a second embodiment f the present invention.

FIG. 6 is a block diagram illustrating a construction of the encoder part 51a in the multi-input encoder 51 of the second embodiment.

FIG. 7 is a block diagram illustrating a construction of a multi-input coding adder 70 according to a third embodiment f the present invention.

FIG. 8 is a block diagram illustrating a construction of the encoder part 71a in the multi-input encoder 17 of the third embodiment.

FIG. 9 is a diagram illustrating a construction of a conventional multi-input multiplier and adder.

FIG. 10 is a diagram illustrating an example of a conventional multi-input multiplier and adder.

FIG. 11 is a diagram illustrating an operation employing a secondary Booth-algorithm.

FIG. 12 is a diagram illustrating a partial product which is generated according to a bit pattern in the secondary Booth-algorithm.

FIG. 13 is a diagram illustrating a construction of the encoder part 51a in the multi-input encoder 51 of the second embodiment.

FIG. 14 is a diagram illustrating a construction of the encoder part 71a in the multi-input encoder 71 of the third embodiment.

### DESCRIPTION OF REFERENCE NUMERALS

11, 51, 71 . . . multi-input encoder
11a, 51a, and 71a . . . encoder part
11b, 51b, 71b . . . encoder unit
12, 52, and 72 . . . multi-input adder circuit
2a, 2b, 2c, 2n . . . two-input adder circuit block
3 . . . inverter
4, 54 . . . constant
5, 5a, 5b, 5c . . . adder circuit
6 . . . selection circuit
7 . . . coefficient pattern
8, 8a, 8b . . . bit-shift circuit
9 . . . column position adjustment circuit
10a, 10b, 10c, 10d . . . partial product generator circuit
11a, 11b, 11c, and 11d . . . multiplier circuit

### BEST MODE TO EXECUTE THE INVENTION

Hereinafter, embodiments of the present invention will be described with reference to the drawings.

### First Embodiment

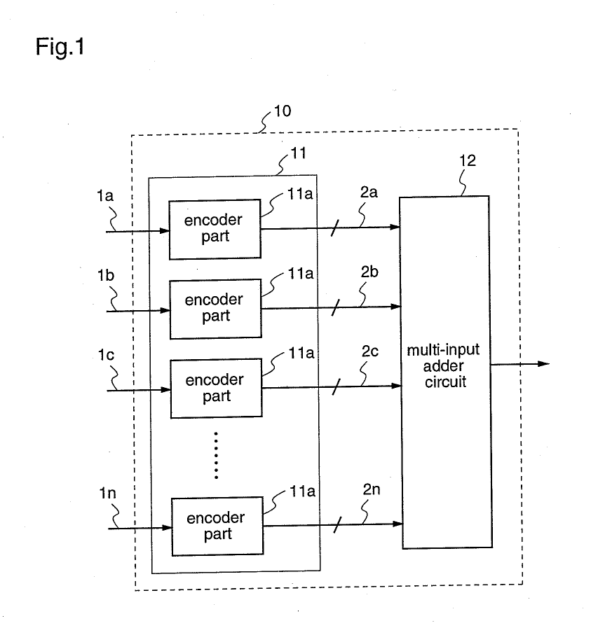

A multi-input coding adder according to a first embodiment of the present invention will be described with reference to FIGS. 1, 2, 3, 4, 11, and 12.

FIG. 1 is a block diagram illustrating the multi-input coding adder of the first embodiment of the present invention. In FIG. 1, reference numeral 11 denotes a multi-input encoder and numeral 12 denotes a multi-input adder circuit.

The multi-input encoder 11 makes the plural inputs 1a, 1b, 1c, 1n subjected to encoding by the respective encoder parts 11a, and outputs plural encoded signals 2a, 2b, 2c, . . . , 2n, respectively.

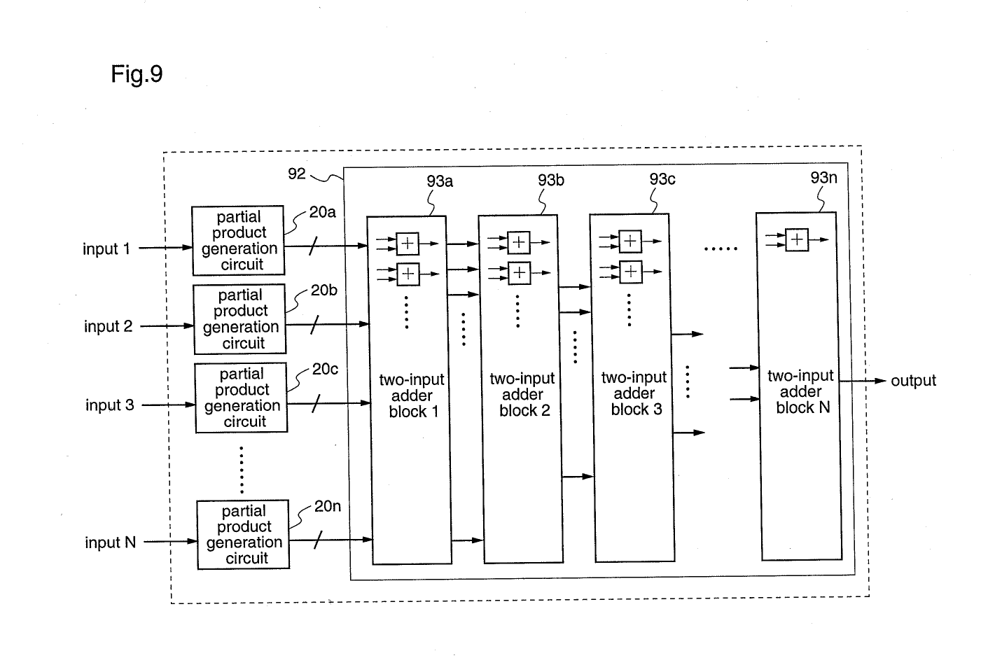

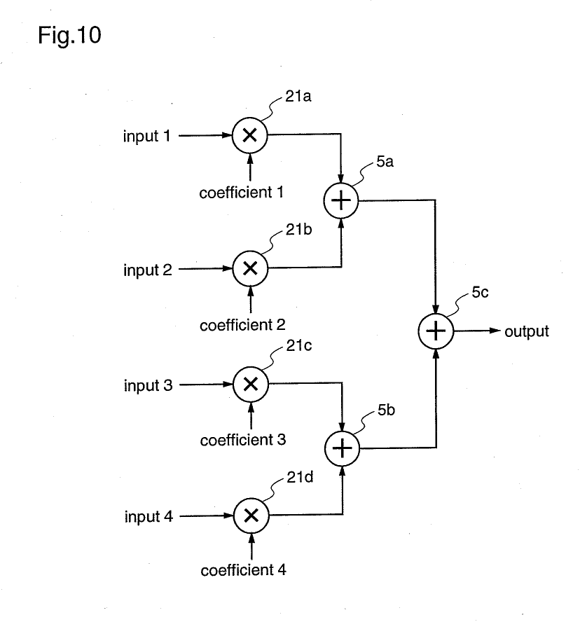

The multi-input adder circuit 12 receives the plural outputs 2a, 2b, 2c, . . . , 2n which are outputted from the respective encoder parts 11a in the multi-input encoder 11 as its inputs, and calculates the total sum of those. As the multi-input adder circuit 12, one which is provided with plural stages of two-input adder blocks similarly as in the multi-input adder circuit 92 in the conventional multi-input multiplier and adder shown in FIG. 9 can be employed. Further, by employing such as a multi-input Wallace Tree adder circuit as the multi-input adder circuit 12, it is possible to realize miniaturization of the addition circuit.

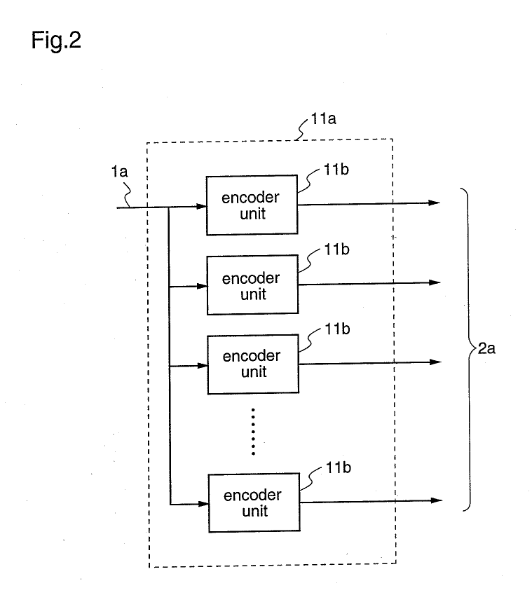

FIG. 2 is a block diagram illustrating a construction of the respective encoder parts 11a in the multi-input encoder 11. In FIG. 2, the encoder part 11a is further constituted by plural encoder units 11b, where each of the respective encoder units 11b encodes the input signal for each one bit or for each several bits, and outputs an encoded signal 2a comprising plural bits.

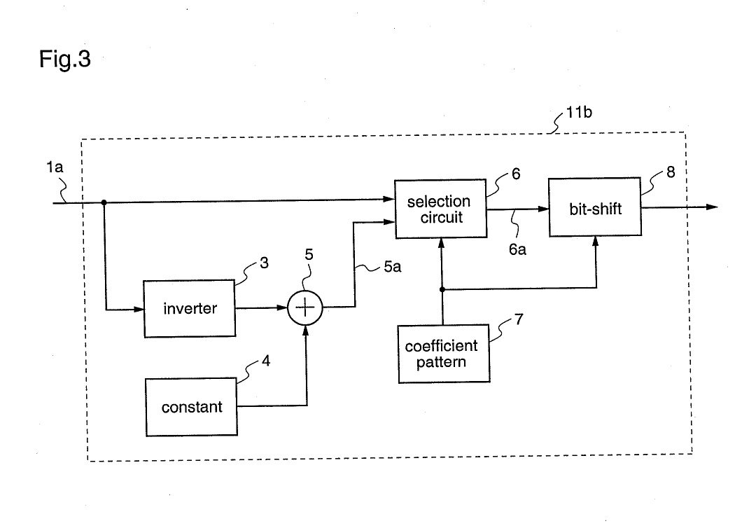

FIG. 3 is a block diagram illustrating an example of construction of an encoder unit 11b in each of the encoder parts 11a which constitute the multi-input encoder 11. In FIG. 3, numeral 3 denotes an inverter, numeral 4 denotes a constant, numeral 5 denotes an adder circuit, numeral 6 denotes a selection circuit, numeral 7 denotes a coefficient pattern, and numeral 8 denotes a bit-shift circuit.

The inverter 3 is operated to generate an inverted signal for each bit of the input signal, and a constant 4 is added to the output of the inverter 3 by the addition circuit 5. Here, the value of the constant 4 is “1”, and by the inverter 3, the constant 4, and the addition circuit 5, 2's complement (sign inversion) of the input is obtained.

Next, either of the input signal 1a or the output signal 5a of the adder circuit 5 is selected by the selection circuit 6 according to the coefficient patter 7 which is obtained by partitioning the fixed multiplier, and the result is multiplied by “0” or “1” to output the obtained signal. Further, the bit-shift circuit 8 outputs the output signal 6a of the section circuit 6 with varying the bit-shift amount thereof.

In the encoder unit 11b in the example shown in FIG. 3, a secondary Booth-algorithm is employed.

Usually, according to the Booth-algorithm, signals of 0 times, +k times, and −k times of the input are outputted according to the bit patterns which are obtained by partitioning the multiplier into each n bits. Here, k is an integer from 1 to n−1. According to the secondary Booth-algorithm, partial products are generated each for 2 bits of the multiplier. However, since 1 bit overlaps, partial products of 0, +X, and +2X for the input signal X are generated corresponding to the successive 3 bits bit patterns of the multiplier Y, as shown in FIG. 12. Then, the partitioning into three bits is carried out with assuming that the lowest column of the multiplier has “0” at its further lower column. The generation of negative numbers is carried out such that the respective bits of X are inverted and “0” is added thereto, since the multiplicand X is in an expression of 2's complement. Further, the generation of 2X is realized by one-bit shifting.

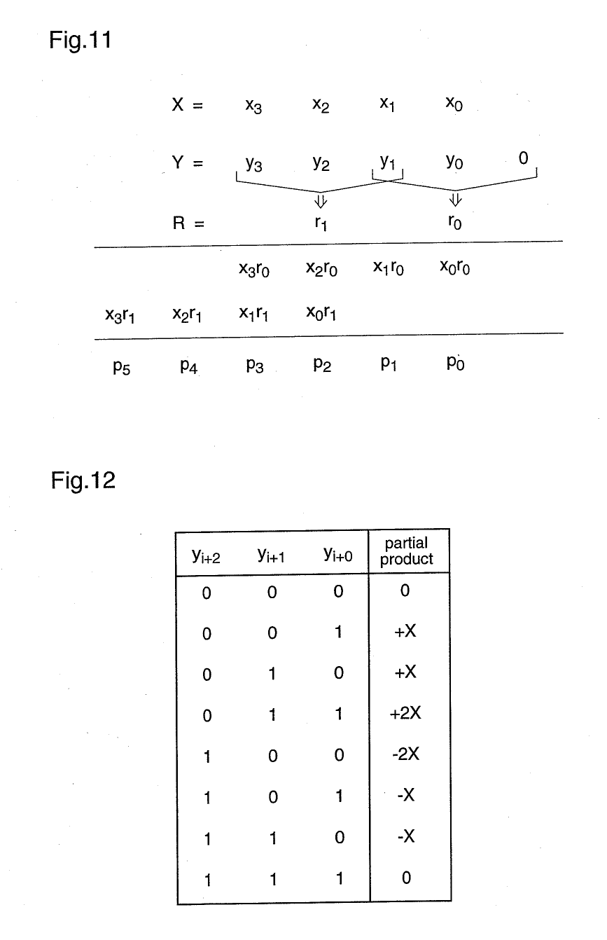

FIG. 11 is a diagram illustrating an operation employing a secondary Booth-algorithm in a case where the input X as the multiplicand is 4 bit (x₃, x₂, x₁, x₀) and the fixed multiplier Y is (y₃, y₂, y₁, y₀) The multiplied value of the input X and the fixed multiplier Y is calculated by that the fixed multiplier Y is divided into each three bits with “0” being added to the lower column than the lowest column thereof, the resulted respective bit patterns are symbolized as r₀ and r₁, and these partial products r₀(x₃, x₂, x₁, x₀) and r₁(x₃, x₂, x₁, x₀) are added together.

More particularly, the construction and operation of the encoder part 11a in a case where the fixed multiplier Y is 4 bits of (0101) will be described. In a case where the fixed multiplier Y is (1010), if “0” is added to a lower bit than the lowest bit of the fixed multiplier Y and the partitioning into three bits is performed, coefficient patterns (100), (101) from the lower bit side are obtained. Therefore, the encoder part 11a is constituted by two encoder units 11b, i.e., the lower bit side encoder unit 11b which has a coefficient pattern 7 of (100) and the upper bit side encoder unit 11b which has a coefficient pattern 7 of (101). In the lower bit side encoder unit 11b having the coefficient pattern 7 of (100), in order to generate a partial product of −2X for the input X, the output signal 5a of the adder circuit 6 is selected by the selection circuit 6, it is multiplied by “1” to be outputted, and the bit-shift circuit 8 outputs the output signal 6a of the selection circuit 6 with bit-shifting it by one-bit. On the other hand, in the upper bit side encoder unit 11b which has the coefficient pattern 7 of (101), in order to generate a partial product of −X for the input X, the output signal 5a of the adder circuit 5 is selected by the selection circuit 6, it is multiplied by “1” to be outputted, and the bit-shift circuit 8 outputs the output signal 6a of the selection circuit 6 as it is without bit-shifting the same.

By employing an encoder unit 11b which employs Booth-algorithm in the multiplication with a fixed multiplier, it is possible to constitute a multi-input coding adder 10 shown in FIG. 1 with a miniaturized circuit, without employing a partial product generator circuit employing a logical product operation.

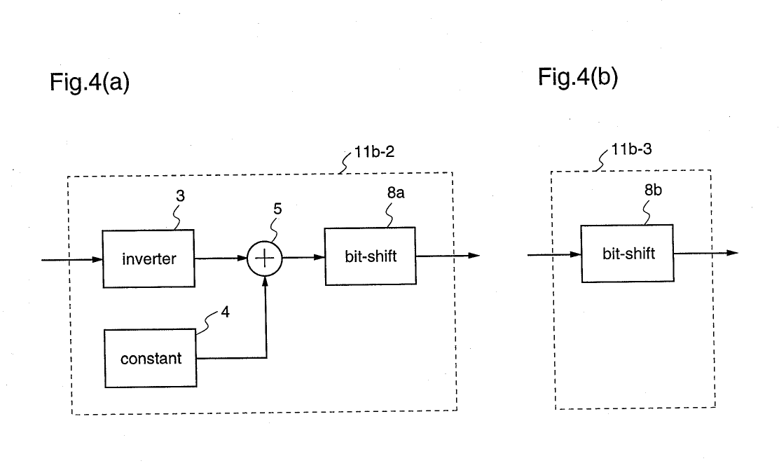

FIGS. 4(a) and 4(b) are block diagrams illustrating other construction examples 11b-2 and 11b-3 of the encoder unit 11b in each encoder part 11a which constitute the multi-input encoder 11.

In the encoder unit 11b-2 shown in FIG. 4(a), numeral 3 denotes an inverter, numeral 4 denotes a constant, numeral 5 denotes an adder circuit, and numeral 8a denotes a bit-shift circuit.

In encoder unit 11b-3 shown in FIG. 4(b), numeral 8b denotes a bit-shift circuit.

The operations of the respective circuits such as the inverter 3 in the encoder unit 11b-2 shown in FIG. 4(a) and the encoder unit 11b-3 shown in FIG. 4(b) are the same as the operations of the respective circuits in the encoder unit 11b shown in FIG. 3.

Since when the secondary Booth-algorithm is employed, which of the partial products of “0”, ±X, and ±2X for the input X is generated is previously determined according to the coefficient pattern of the multiplier, the encoder unit 11b shown in FIG. 3 may be replaced by the encoder unit 11b-2 shown in FIG. 4(a), or by the encoder unit 11b-2 shown in FIG. 11b-3 according to the bit pattern of the multiplier. By constituting the encoder unit 11b of the encoder part 11a shown in FIG. 2 by the encoder unit 11b-2 shown in FIG. 4(a) or the encoder unit 11b-3 shown in FIG. 4(b) according to the coefficient pattern of the multiplier, it is possible to construct the respective encoder units as those which do not include circuits which are not used, thereby realizing the miniaturization of the circuit.

Besides, the multi-input coding adder according to the first embodiment may be realized by a specified use hardware. Or, in place of realized by a specified use hardware, it may be realized by a synthesizer device which comprises a general purpose computer and synthesizes a multi-input coding adder of this embodiment by execution of a program. When the multi-input coding adder of this embodiment is realized by a synthesizer device, a synthesizing program which, when executed by a computer, synthesizes a multi-input coding adder of this embodiment may be recorded in an information recording medium such as CD so that when the program is read out from the recording medium storing that program and is executed, the multi-input coding adder of this embodiment should be synthesized.

Further, the multi-input coding adder of this first embodiment may be employed so as to constitute a signal processing device which performs a signal processing including a processing that multiplies the plural inputs by fixed multipliers respectively and adds all the multiplication results. Further, it is also possible to employ it as a means which multiplies the plural inputs by fixed multipliers respectively and adds all the multiplication results, in a digital filter which is provided with means which multiplies the plural inputs by fixed multipliers respectively and adds all the multiplication results.

In this way, according to the multi-input coding adder of this first embodiment, by constructing as described above, i.e., by constructing, without employing partial product generator circuits, a circuit that can perform equivalent functions to those circuits employing a small-sized multi-input encoder and a multi-input adder circuit, it is possible to realize reduction in circuits and further to realize an operator which can perform operations equivalent to those in the conventional multi-input multiplication and adder circuit, with a small-sized circuit configuration.

### Second Embodiment

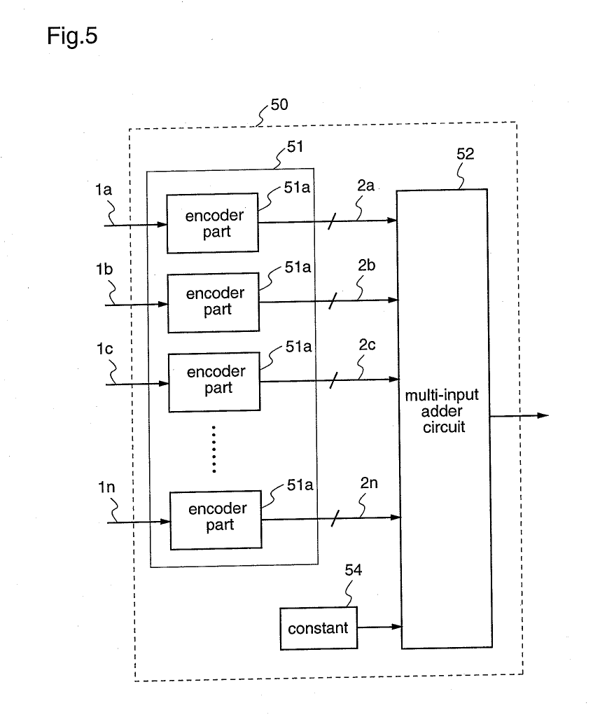

A multi-input coding adder according to a second embodiment of the present invention will be described with reference to FIGS. 5, 6, and 13.

FIG. 5 is a block diagram illustrating a multi-input coding adder according to this second embodiment.

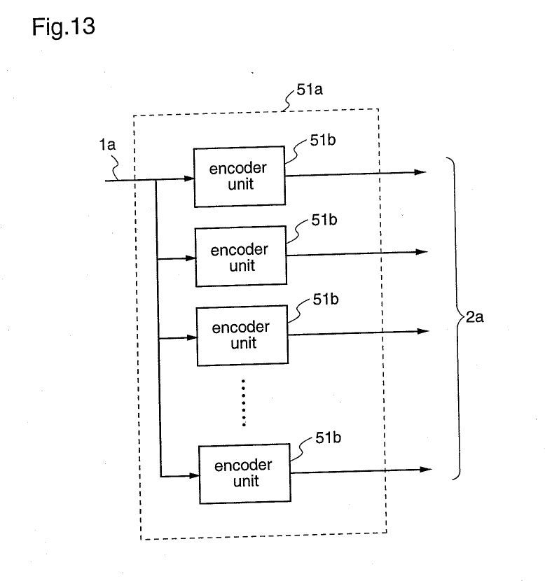

In FIG. 5, numeral 50 denotes a multi-input coding adder of the second embodiment, numeral 51 denotes a multi-input encoder, numeral 51a denotes an encoder part in the multi-input encoder 51, numeral 52 denotes a multi-input adder circuit, and numeral 54 denotes a constant. In addition, FIG. 13 is a diagram illustrating a construction of the encoder part 51a in the multi-input encoder 51 of the second embodiment. In FIG. 13, the encoder part 51a is further constituted by plural encoder units 51b, where each of the respective encoder units 51b encodes the input signal for each one bit or for each several bits, and outputs an encoded signal 2a comprising plural bits.

In FIG. 5, the difference of this second embodiment from the first embodiment shown in FIG. 1 resides in that a constant 54 is added at the input of the multi-input adder circuit 52.

In this second embodiment, the multi-input adder circuit 52 calculates the total sum of the plural encode signals 2a, 2b, 2c, . . . , 2n which are plural outputs of the multi-input encoder 51 and the constant 54.

Next, the construction of the encoder units 51b which constitute the encoder part 51a in the multi-input encoder 51, in the construction of the multi-input coding adder 50 of this second embodiment shown in FIG. 5 will be described.

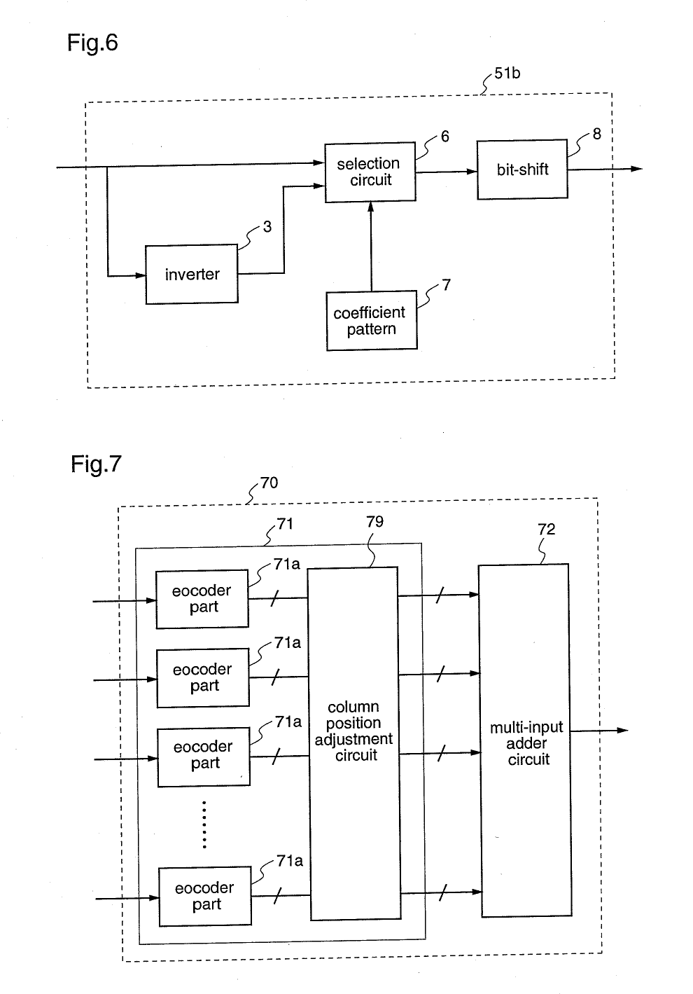

FIG. 6 is a block diagram illustrating an example of construction of the encoder unit 51b which constitutes the encoder part 51a in the multi-input encoder 51 in this second embodiment.

In FIG. 6, numeral 3 denotes an inverter, numeral 6 denotes a selection circuit, numeral 7 denotes a coefficient pattern, and numeral 8 denotes a bit-shift circuit.

The difference of the encoder unit 51b in this second embodiment shown in FIG. 6 from the encoder unit 11b in the first embodiment shown in FIG. 3 resides in that the constant 4 and the adder circuit 5 in the encoder unit 11b shown in FIG. 3 are omitted in the encoder unit 51b shown in FIG. 6.

While in the first embodiment, the constant 4 and the addition circuit 5 are provided inside the encoder unit 11b, in this second embodiment, the constant addition in the plural encoder units 11b by the constant 4 and the addition circuit 5 are collectively replaced by a constant, i.e., a constant 54 shown in FIG. 5 to be used for addition.

In this second embodiment as described above, by collecting the constant additions in the respective encoder units 51b as a constant addition 54 and making it as an input to the multi-input adder circuit 52, the respective encoder units 51b are not required to have constants and adder circuits therein respectively, and thereby the circuit scale can be further reduced.

In this way, according to the multi-input coding adder of this second embodiment, by constructing as described above, i.e., by constructing a circuit employing a small-sized multi-input encoder and a multi-input adder, without employing partial product generator circuits, it is possible to realize reduction in circuits, and further to realize an operator that can perform an operation that is equivalent to that in the conventional multi-input multiplication and adder circuit, with a miniaturized circuit configuration.

### Third Embodiment

A multi-input coding adder circuit according to a third embodiment of the present invention will be described with reference to FIGS. 7, 8, and 14.

FIG. 7 is a block diagram illustrating a multi-input coding adder 70 according to this third embodiment.

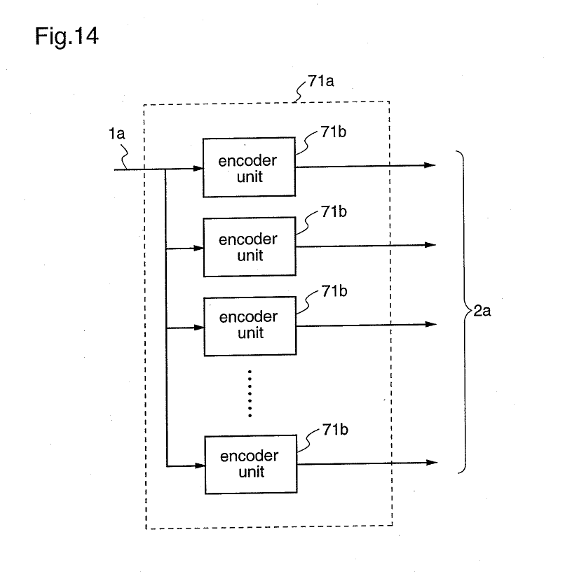

In FIG. 7, numeral 70 denotes a multi-input coding adder of this third embodiment, numeral 71 denotes a multi-input encoder, numeral 71a denotes an encoder part in the multi-input encoder 71, numeral 79 denotes a column position adjustment circuit, and numeral 72 denotes a multi-input adder circuit. In addition, FIG. 14 is a block diagram illustrating a construction of each encoder part 71a in the multi-input encoder 71. In FIG. 14, the encoder part 71a is further constituted by plural encoders 71b, where each of the respective encoders 71b encodes the input signal for each one bit or for each several bits, and outputs an encoded signal 2a comprising plural bits.

In FIG. 7, the difference of this third embodiment from the first embodiment which is shown in FIG. 1 resides in that a column position adjustment circuit 79 is provided in the multi-input encoder 71.

Next, the construction of the encoder parts 71a in the multi-input encoder 71, in the construction of the multi-input coding adder 70 of the third embodiment shown in FIG. 7 will be described.

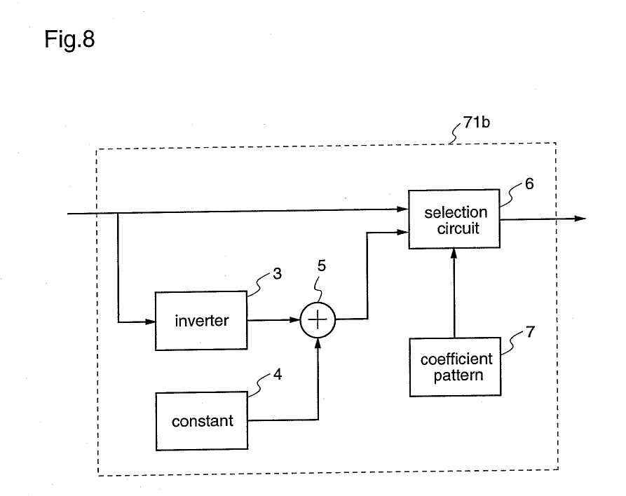

FIG. 8 is a block diagram illustrating an example of construction of the encoder 71b which constitutes the encoder part 71a in the multi-input encoder 71 in this third embodiment.

In FIG. 8, numeral 3 denotes an inverter, numeral 4 denotes a constant, numeral 5 denotes an adder circuit, numeral 6 denotes a selection circuit, and numeral 7 denotes a coefficient pattern.

The difference of the encoder unit 71b in this third embodiment shown in FIG. 8 from the encoder unit 11b in the first embodiment shown in FIG. 3 resides in that the bit-shift circuit 8 in the encoder unit 11b shown in FIG. 3 is omitted in the encoder unit 71b shown in FIG. 8.

In this third embodiment, in place of the bit-shift circuit 8 is omitted in the encoder unit as shown in FIG. 8, the column position adjustment circuit 79 is added in the multi-input encoder 71, as shown in FIG. 7.

The bit-shifting by the bit-shift circuit 8 shown in FIG. 3 corresponds to adjusting the column position in the multi-input adder circuit 12, and the column position adjustment circuit 79 adjusts the column positions of the plural outputs from the respective encoder parts 71a respectively, to output the results to the multi-input adder circuit 72. This column position adjustment circuit 79 has unique column adjustment positions when the multiplier is a fixed multiplier having a fixed pattern. This circuit only designates the paths of addition operation (column positions) in the multiplication, which would arise no addition of extra circuits.

In such third embodiment, by adjusting the column positions of the outputs of the respective encoder parts 71a by the column position adjustment circuit 79, the respective encoder units 71b can be made those which include no bit-shift circuits therein, and thereby, the circuit scale can be further reduced.

In this way, according to the multi-input coding adder of this third embodiment, by constructing as described above, i.e., by constructing a circuit employing a small-sized multi-input encoder and a multi-input adder, without employing partial product generator circuits, it is possible to realize reduction in circuits, and further to realize an operator which can perform an operation that is equivalent to that in the conventional multi-input multiplication and adder circuit, with a miniaturized circuit configuration.

While in the above embodiments, as encoders, those which are constituted by employing a secondary Booth-algorithm are employed, encoders used in the present invention are not limited to those which utilize secondary Booth-algorithm, but those which utilize other algorithms such as tertiary Booth-algorithm may be employed.

### APPLICABILITY IN INDUSTRY

According to the multi-input coding adder of the present invention, by employing a small-sized multi-input encoder and a multi-input adder circuit, it is possible to realize a small-sized multi-input multiplication and addition circuit, and it is very useful as a multi-input multiplication and addition circuit which performs various signal processing or used in a digital filter. In addition, it is applicable in fundamental operation devices for all kinds of digital signal processing as those used in optical recording and reproduction devices or in various uses for such as communications.

1-7. (canceled)

8. A multi-input coding adder, being an operator which multiplies a plurality of inputs by fixed multipliers, respectively, and adds all the multiplication results together, comprising:
a multi-input encoder which, comprising a plurality of encoder parts each of which accomplishes a function corresponding to generation of a partial product in a multiplication, each of the plural inputs to which encoder is an input of each said encoder part, and which encoder has plural outputs each of which is the multi-input output of each said encoder part, and
a multi-input adder circuit which adds the plural outputs of said multi-input encoder which are the multi-bit output of each said encoder part, and a constant.

9. A multi-input coding adder circuit as defined in claim 8, wherein:
each said encoder part constituting said multi-input encoder includes a plurality of encoder units which generate respectively partial products which respectively correspond to the plural coefficient patterns which are obtained by partitioning the bit pattern of the fixed multiplier into each plural bits, and
at least one of said plural encoder units comprises:
an inverter for inverting each bit of said input signal;
an adder circuit which adds a constant to the output of said inverter;
a selection circuit for selecting either of said input signal and the output signal of said adder circuit according to said coefficient pattern to output the selected result; and
a bit-shift circuit which carries out a bit-shift of the output signal of said selection circuit.

10. A multi-input coding adder, being an operator which multiplies a plurality of inputs by fixed multipliers, respectively, and adds all the multiplication results together to output the added result, comprising:
a multi-input encoder which, comprising a plurality of encoder parts each of which accomplishes a function corresponding to generation of a partial product in a multiplication, each of the plural inputs to which encoder is an input of each said encoder part, and which encoder has plural outputs each of which is the multi-input output of each said encoder part, and
a column position adjusting circuit which, with receiving the multi-bit outputs of the respective encoder parts which constitute said multi-input encoder as its inputs, carries out an adjustment of the column positions of said respective inputs.

11. A multi-input coding adder circuit as defined in claim 10, wherein:
each said encoder part constituting said multi-input encoder includes a plurality of encoder units which generate respectively partial products which respectively correspond to plural coefficient patterns which are obtained by partitioning the bit pattern of the fixed multiplier into each plural bits, and
at least one of said plural encoder units comprises:
an inverter for inverting each bit of said input signal;
an adder circuit which adds a constant to the output of said inverter;
a selection circuit for selecting either of said input signal and the output signal of said adder circuit according to said coefficient pattern to output the selected result; and
a bit-shift circuit which carries out a bit-shift of the output signal of said selection circuit.

12-17. (canceled)
